(19) United States
(12) Patent Application Publication
(10) Pub. No.: US 2023/0170119 A1
(43) Pub. Date: Jun. 1, 2023

(54) Mirrored Winding Pack for Stacked-Plate Superconducting Magnets

(71) Applicant: Massachusetts Institute of Technology, Cambridge, MA (US)

(72) Inventor: Brian LABOMBARD, Belmont, MA (US)

(73) Assignee: Massachusetts Institute of Technology, Cambridge, MA (US)

(21) Appl. No.: 17/919,942

(22) PCT Filed: Feb. 22, 2021
(86) PCT No.: PCT/US2021/018962

§ 371 Date: Oct. 19, 2022

Related U.S. Application Data
(60) Provisional application No. 63/027,538, filed on May 20, 2020.

(51) Int. Cl. H01F 6/06; H01B 12/10; H01F 6/04

(52) U.S. Cl. CPC H01F 6/06; H01B 12/10; H01F 6/04

(57) ABSTRACT

Magnets and magnet systems include stacked magnet baseplates. Each of the plates includes grooves that contain windings of a conductor (e.g. a high temperature superconductor) that generates a magnetic field when current is passed through. This field generates Lorentz forces in the stack that press the conductors in different directions and with different magnitudes. Thus, the plates are oppositely oriented (mirrored) so that these forces always press the conductors into the grooves, rather than pulling them out of the grooves. The conductors may be further reinforced in their grooves with solder or epoxy potting. Some stacks may have more plates in one orientation than in the mirrored orientation, because the Lorentz forces need not be symmetrical with respect to a midpoint of the stack, e.g. when the system experiences externally-applied magnetic fields. Additional, mirrored side plates may be added in some configurations.

### FIELD

The disclosure pertains generally to superconducting magnets, and more particularly to stacking of plates, that contain wound superconductors, according to desired Lorentz loading.

### BACKGROUND

Superconducting magnets with non-insulated (NI) high temperature superconductor (HTS) windings have demonstrated the ability to enhance superconducting magnet performance in three key metrics: overall current density, thermal stability, and mechanical integrity. A spiral-grooved, stacked-plate, non-insulated superconducting magnet design was conceived to fully exploit these characteristics in a design that is both commercially viable and scalable to large bore magnets—pushing system performance to handle the highest magnetic fields and stored magnetic energies possible. This design utilizes a structurally robust spiral-grooved baseplate as the basic building block. Grooves are loaded with a composite of HTS tapes and co-wind materials in a variety of configurations. These are assembled into single or double pancake modules, which are stacked together to form the winding pack for a high field magnet. Further details of this design may be found in U.S. application Ser. No. 16/233,410, filed Dec. 27, 2018 and entitled “Spiral-Grooved, Stacked-Plate Superconducting Magnets And Related Construction Techniques,” the entire contents of which are incorporated herein by reference.

### SUMMARY OF DISCLOSED EMBODIMENTS

Disclosed embodiments include magnet plates stacked in a pattern that is a function of the expected operational field strength at different positions in the stack, thereby ensuring that the resulting loads always are directed into the grooves, and thus onto the structural plate itself. This is accomplished by altering the baseplate orientations, e.g. by ‘flipping’ the geometry of the plates such that the conductor placement in the lower half of the stack ‘mirrors’ that of the upper half, and applying suitable modifications to the mechanical fasteners and electrical joints. A winding pack with this design provides several advantages, at least: greater flexibility in the choice of materials used to secure the conductor in its groove, reduced structural requirements of those materials, greater manufacturing tolerances, increased inherent tolerance to construction flaws, or a combination thereof.

Thus, a first embodiment is a system comprising a plurality of magnet plates. Each of the magnet plates has a flat surface opposite a grooved surface. Each of the magnet plates also has a conductor that passes through grooves in the grooved surface. The plurality of magnet plates are arranged in a stack so that, when a current is applied to the conductor of each of the magnet plates to generate a magnetic field, a Lorentz force resulting from the generated magnetic field presses each conductor into its respective grooves.

In some embodiments, one half of the magnet plates have grooved surfaces arranged toward a top of the stack, and the other half of the magnet plates have grooved surfaces arranged toward a bottom of the stack. Some embodiments further have a second plurality of magnet plates, each of the second plurality of magnet plates having a flat surface and a grooved surface, each of the second plurality of magnet plates having a conductor that passes through grooves in the grooved surface. In these embodiments, one half of the second plurality of magnet plates have grooved surfaces arranged toward a left of the stack, and the other half of the magnet plates have grooved surfaces arranged toward a right of the stack. Thus, the second plurality of magnet plates have an orientation that is perpendicular to an orientation of the first plurality of magnet plates.

In some embodiments, greater than one half of the magnet plates have grooved surfaces arranged toward a top of the stack, and the remaining fewer than one half of the magnet plates have grooved surfaces arranged toward a bottom of the stack.

In some embodiments, at least one of the magnet plates has a conductor that comprises a homogeneous rare-earth copper oxide superconductor.

In some embodiments, at least one of the magnet plates has a conductor that comprises a stack of high temperature superconductor (HTS) tape. The conductor may have a circular cross-section, or a square cross-section, or another shape of cross-section.

In some embodiments, at least one of the magnet plates has a conductor that comprises a plurality of stacks of high temperature superconductor (HTS) tape. The plurality of stacks of HTS tape may be arranged around a cooling channel for removing heat generated by the plurality of stacks of HTS tape.

In some embodiments, at least one of the magnet plates has a conductor that is soldered into the grooves in the grooved surface, or is potted into the grooves in the grooved surface using an epoxy.

In some embodiments, at least one of the magnet plates comprises a steel or a glass-fiber composite.

Another embodiment is a housing having grooved surfaces, the housing having a plurality of conductors that each pass through a groove in one of the grooved surfaces. When a current is applied to each of the plurality of conductors to generate a magnetic field, a Lorentz force resulting from the generated magnetic field presses each conductor into its respective groove.

In some embodiments, at least one of the plurality of conductors comprises a homogeneous rare-earth copper oxide superconductor.

In some embodiments, at least one of the plurality of conductors comprises a stack of high temperature superconductor (HTS) tape. The conductor may have a circular cross-section, or a square cross-section, or another shape of cross-section.

In some embodiments, at least one of the plurality of conductors comprises a plurality of stacks of high temperature superconductor (HTS) tape. The plurality of stacks of HTS tape may be arranged around a cooling channel for removing heat generated by the plurality of stacks of HTS tape.

In some embodiments, at least one of the plurality of conductors is soldered into its groove, or is potted into its groove using an epoxy.

In some embodiments, the housing comprises a steel or a glass-fiber composite.

Yet another embodiment is a magnet system comprising a plurality of magnet winding packs. Each winding pack has a plurality of magnet plates. Each of the magnet plates has a flat surface opposite a grooved surface, and a conductor that passes through grooves in the grooved surface. The plurality of magnet plates are arranged in each winding pack so that, when a current is applied to the conductor of each of the magnet plates to generate a magnetic field, a Lorentz force resulting from the generated magnetic field presses each conductor into its respective grooves.

In some embodiments, at least two of the magnet winding packs have different arrangements of magnet plates. The magnet system may be arranged as a solenoid, or arranged as a toroid.

A further embodiment is a magnet comprising a plurality of plates, each of the plates having a flat surface opposite a grooved surface, each of the plates comprising a conductor that passes through grooves in the grooved surface. The plurality of plates includes a first plate and a second plate arranged such that the flat surface of the first plate and the flat surface of the second plate both lie between the grooved surface of the first plate and the grooved surface of the second plate.

In some embodiments, the flat surface of the first plate contacts the flat surface of the second plate.

In some embodiments, the flat surface of the first plate and the flat surface of the second plate contact opposing sides of a layer of insulation.

In some embodiments, at least one of the plates comprises a conductor having a stack of high temperature superconductor tapes. The conductor may have a circular cross-section or a square cross-section.

It is appreciated that the concepts, techniques, and structures disclosed herein may be embodied in other ways, and that the listing of certain embodiments above does not limit the inventive scope of this disclosure.

### DESCRIPTION OF THE SEVERAL VIEWS OF THE DRAWINGS

The manner and process of making and using the disclosed embodiments may be appreciated by reference to the figure of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a cross-sectional view of a mirrored stack of magnet plates, each plate containing several grooves, each groove containing a conductor having a circular cross-section;

FIG. 2 is a cross-sectional view of a mirrored stack of the magnet plates as in FIG. 1, with additional, mirrored, side magnet plates;

FIG. 3 is a cross-sectional view of an asymmetrically mirrored stack of the magnet plates;

FIG. 4 is a cross-sectional view of a single magnet plate having several grooves in which the conductor is arranged in radial layers;

FIG. 5 is a cross-sectional view of a mirrored stack of magnet plates, each plate containing several grooves, each groove containing a conductor having a circular cross-section and containing a stack of high-temperature superconductor (HTS) tape;

FIG. 6 is a cross-sectional view of a mirrored stack of the magnet plates as in FIG. 5, with additional, mirrored, side magnet plates;

FIG. 7 is a cross-sectional view of an asymmetrically mirrored stack of the magnet plates;

FIG. 8 is a cross-sectional view of a single magnet plate having several grooves in which the circular conductors are arranged in radial layers;

FIG. 9 is a cross-sectional view of a mirrored stack of magnet plates, each plate containing several grooves, each groove containing a conductor having a square cross-section containing a stack of high-temperature superconductor (HTS) tape;

FIG. 10 is a cross-sectional view of a mirrored stack of the magnet plates as in FIG. 9, with additional, mirrored, side magnet plates;

FIG. 11 is a cross-sectional view of an asymmetrically mirrored stack of the magnet plates;

FIG. 12 is a cross-sectional view of a single magnet plate having several grooves in which the square conductors are arranged in radial layers;

FIG. 13 is a cross-sectional view of a mirrored stack of magnet plates, each plate containing several grooves, each groove containing a conductor having a circular cross-section with several stacks of high-temperature superconductor (HTS) tape around a cooling channel;

FIG. 14 is a cross-sectional view of a mirrored stack of the magnet plates as in FIG. 13, with additional, mirrored, side magnet plates;

FIG. 15 is a cross-sectional view of an asymmetrically mirrored stack of the magnet plates;

FIG. 16 is a cross-sectional view of a single magnet plate having several grooves in which the circular conductors are arranged in radial layers; and

FIG. 17 is a cross-sectional view of several stacks of magnet plates having different mirroring arrangements for use at different positions in a solenoid, each plate containing several grooves, each groove containing a conductor.

### DETAILED DESCRIPTION OF EMBODIMENTS

Large magnetic self-fields develop in the winding packs of superconducting magnets during operation. Consequently, large Lorentz loads develop on the conductors. For winding packs that consist of a series of stacked plates, each with conductors embedded into grooves within the plate, the component of Lorentz load that is aligned normal to the plane of the plates, the so-called out-of-plane Lorentz load, plays an important role. Consider a winding pack that is constructed by stacking the plates with all the grooves facing in the same direction. In half of these conductors, as known in prior art winding packs, the loads are directed into their respective grooves, while for the other half of these conductors, the loads are directed out of their respective grooves. Thus, conductors in the latter half experience loads that are not borne by the structural material of the baseplate, but instead by non-structural elements, such as copper caps, solder, or coolant channels.

Disclosed embodiments exploit a fundamental principle of physics; namely that conductors (such as those in a magnet winding pack, for example) having current flowing in parallel to each other are attracted due to the self-magnetic fields. To apply this principle, magnet plates in a stack of magnet plates are oriented so that, under operating self-field, the conductors of each plate pull themselves in a direction which aids the structural integrity of the stack of plates. That is, in accordance with the concepts described herein, it has been recognized that it is possible to arrange (or orient) plates such that forces resultant from current flowing through the conductors disposed in grooves of the plates occur in a desired direction. For example, in embodiments comprising a stack of plates having high temperature superconductors (e.g. an HTS cable or one or more HTS tapes) disposed in grooves thereof, the plates may be oriented such that forces on the HTS push the HTS into the grooves of the plate. That is, the HTS tapes are pulled into (rather than out of) the grooves of the plate.

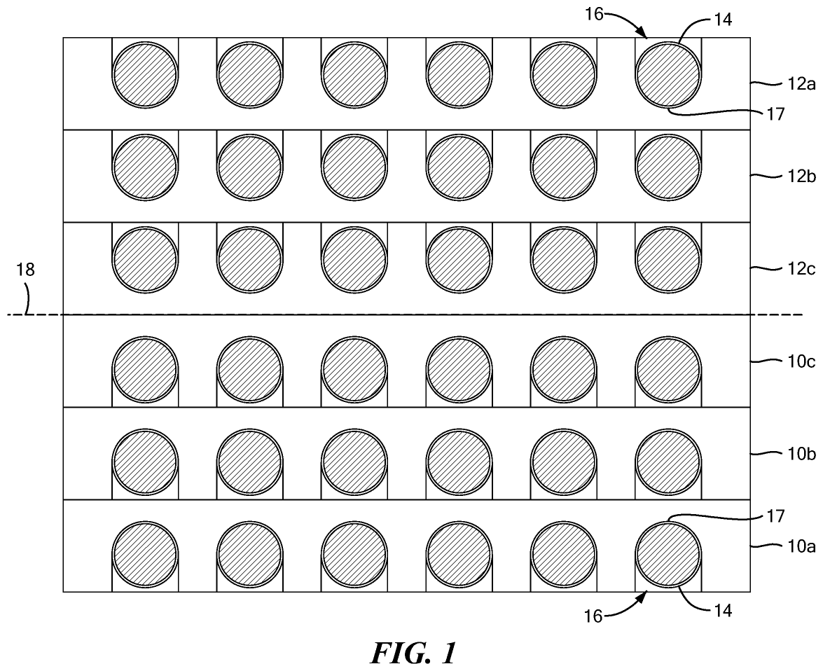

Referring now to FIG. 1, a plurality of magnet plates, here a stack of six magnet plates 10a-10c and 12a-12c, have many superconductors (of which two are labeled 14) disposed in respective grooves 16 thereof. In embodiments, grooves 16 may be provided as spiral-grooves within the plates, in which case the embodiment of FIG. 1 may correspond to a spiral-grooved, stacked plate magnet design. Significantly, the magnet plates are symmetrically disposed about a symmetry plane 18. Thus, it may be said that magnet plates 10a-10c, 12a-12c are “mirrored” about the symmetry plane 18 (e.g. a central symmetry plane). Thus, magnet plate 10a is the mirror image of magnet plate 12a, and likewise for the pairs 10b/12b and 10c/12c. In illustrative embodiments, each plate has a plurality of grooves, and each groove contains a conductor (which may, illustratively, be a homogenous conductor) having a circular cross-section.

A “mirrored” winding pack is one in which the conductor groove geometry is ‘mirrored’ about a central symmetry plane. The spiral-grooved, stacked plate magnet design of FIG. 1 accomplishes this mirrored geometry in a magnet that has no externally applied fields, only the generated self-field. Thus, the bottom three plates 10a-10c in the winding pack are attracted to the top three plates 12a-12c. In other words, every magnet plate is attracted to the central plane 18 of the stack, which is therefore used as the plane of symmetry for the plate geometries.

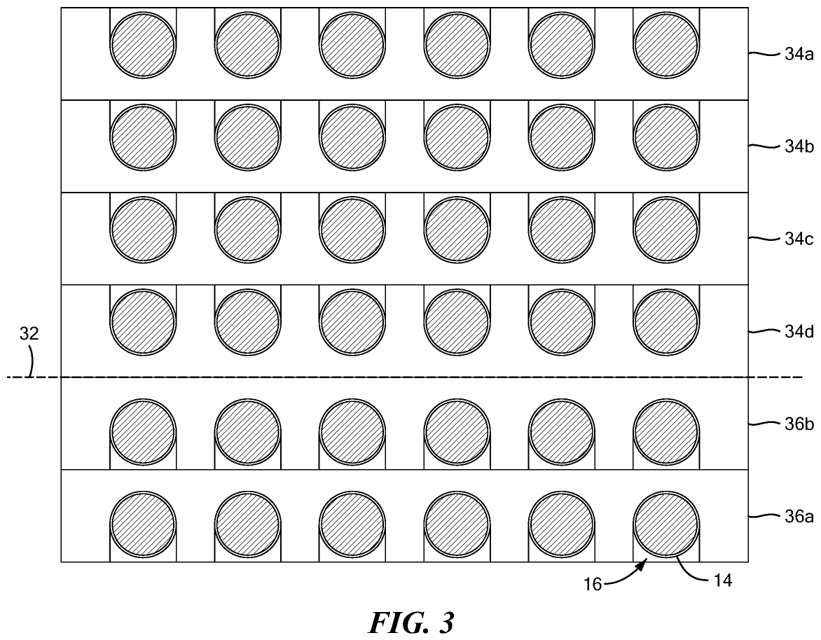

It is recognized that any even number of magnet plates may be mirrored across a central symmetry plane when a symmetric magnetic field is present, and thus that the fact that six magnet plates are shown in FIG. 1 is not limiting. Thus two, four, eight, ten, or more magnet plates (any even number of magnet plates) may be used in the fully symmetric design of FIG. 1, according to the magnet's operating requirements. The case of a magnetic field that is asymmetric with respect to the stack is discussed below, especially in connection with FIG. 3.

This design has certain derivative benefits. For example, in magnet designs having coolant channels between the magnet plates, such channels located at the reflection plane can be reduced significantly in cross-sectional area or eliminated, as desired.

Thus, the embodiment of FIG. 1 has a plurality of magnet plates, each of the magnet plates having a flat surface opposite a grooved surface, each of the magnet plates having a conductor that passes through grooves in the grooved surface. The plurality of magnet plates are arranged in a stack so that, when a current is applied to the conductor of each of the magnet plates to generate a magnetic field, a Lorentz force resulting from the generated magnetic field presses each conductor into its respective grooves. That is, a Lorentz force resulting from operating of the magnet is generally directed (i.e. has a magnitude and direction directed) so as to push or pull the conductor toward the plane of symmetry. One half of the magnet plates 12a-12c have grooved surfaces arranged (i.e. opening) toward a top of the stack, and the other half of the magnet plates have grooved surfaces arranged (i.e. opening) toward a bottom of the stack 10a-10c. Thus, with the plates, grooves and conductors arranged as shown in FIG. 1, the force drives each conductor toward the “bottom” (i.e. innermost) surface of the groove in which it is disposed, e.g. surfaces 17.

It is appreciated that, in some embodiments, each conductor 14 may be either soldered into its groove, or potted using an epoxy. The magnet plates 10a-10c, 12a-12c each may be an electrical conductor, such as steel, but may be an insulator such as a glass-fiber composite.

As will become apparent from the description below, it is recognized that the broad concepts described herein may be applied to many different types of plates, grooves, and cables. The plates, grooves, and cables may be provided having a wide variety of shapes, and several such shapes are illustrated in the Figures herein. Any type of superconducting cable may be disposed in a groove having a cross-sectional shape. In some embodiments, cables (e.g. cables 14) may comprise an HTS tape stack. In some embodiments, cables (e.g. cables 14) may comprise a former having one or more grooves therein into which superconducting material (e.g. HTS tape) may be disposed. Also, cables (e.g. cables 14) may be provided having any regular or irregular cross-sectional shape including, but not limited to round, oval, square or rectangular. Similarly, grooves (e.g. groove 16) may be provided having any regular or irregular cross-sectional shape including, but not limited to round, oval, square or rectangular.

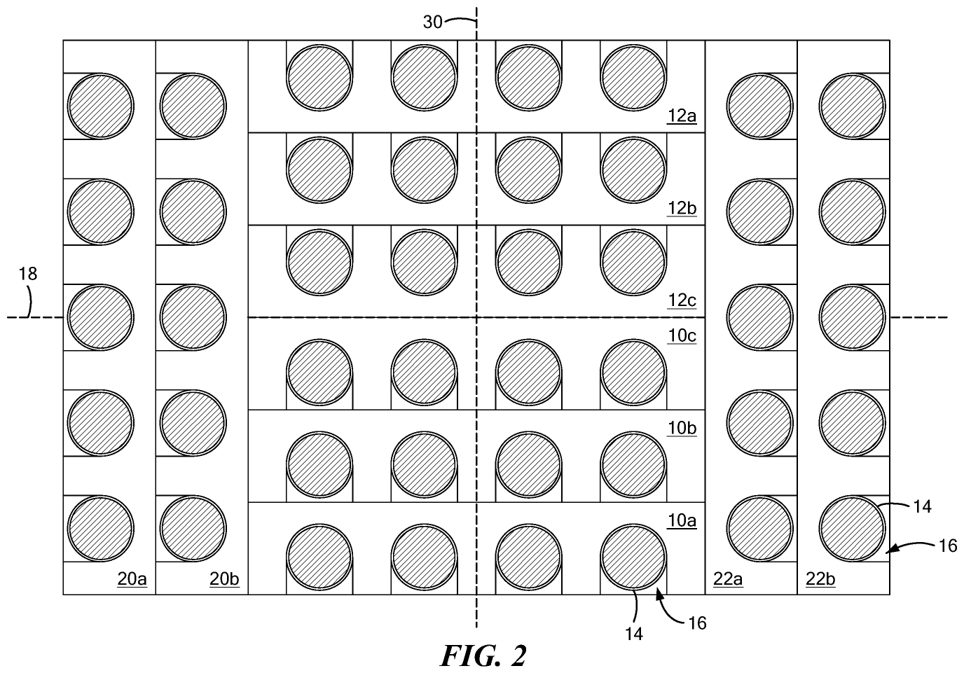

Referring now to FIG. 2, shown is a cross-sectional view of a mirrored stack of the magnet plates as in FIG. 1, with additional, mirrored, side magnet plates 20a, 20b, 22a, 22b. These additional side plates may be added for long, slender sections of a winding pack, for applications in which magnets having this shape are useful. It is appreciated that magnet plates according FIG. 2, if arranged around a curve or bend, may experience undesirable forces that reduce the effectiveness of this configuration by pulling outer conductors away from the center of the structure. These asymmetrical forces may be countered by employing an asymmetrical configuration according to the principles discussed below in connection with FIG. 3.

The embodiment of FIG. 2 has a second plurality of magnet plates 20a, 20b, 22a, 22b similar to the first plurality of magnet plates 10a-10c, 12a-12c. One half of the second plurality of magnet plates (i.e. plates 20a, 20b) have grooved surfaces arranged (or opening) toward a left of the stack, and the other half of the magnet plates (i.e. magnet plates 22a, 22b) have grooved surfaces arranged (or opening) toward a right of the stack. Magnet plates 20a, 20b, 22a, 22b are disposed about a second plane of symmetry 30.

For applications in which the magnet experiences an external field component that is parallel to the plates, the net out-of-plane I×B loads will be shifted about the mirror reflection plane. This situation may be encountered, for example, in a toroidal field (TF) winding pack for a tokamak. In this situation, the TF winding pack will be exposed to magnetic fields generated by the poloidal field (PF) coil set. Because the TF magnet self-fields are much stronger than the PF magnet fields at the location of the TF conductors, the shift in the out-of-plane I×B load pattern is small, but varies according to the position of the plate within the stack.

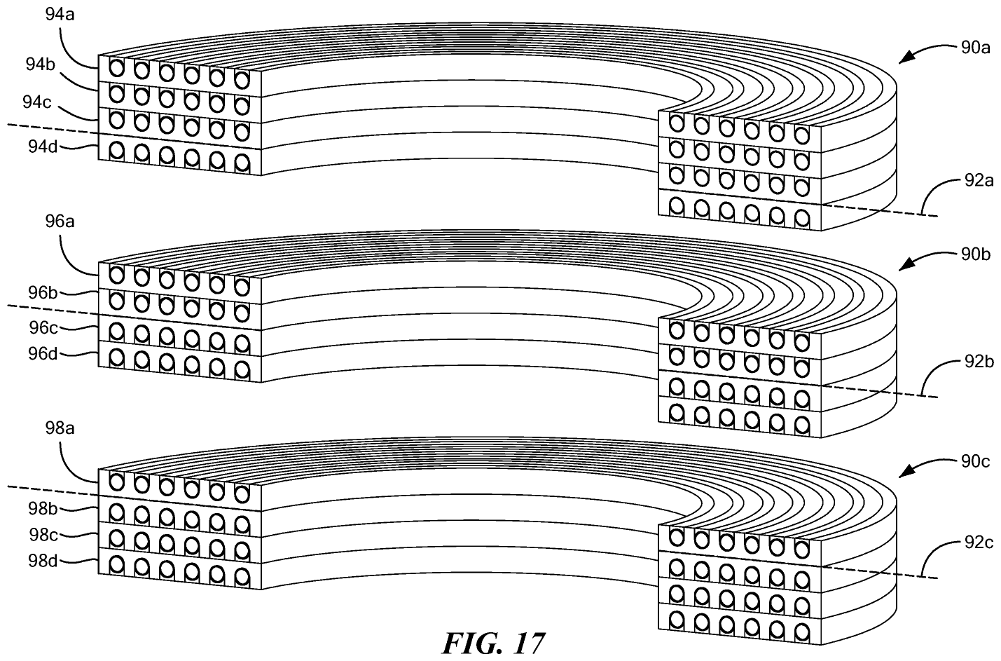

In this connection, in FIG. 3 is shown a cross-sectional view of an asymmetrically mirrored stack of the magnet plates (i.e. mirrored about plane 32). To accommodate the asymmetric loading of the stack, in the embodiment of FIG. 3, greater than one half of the magnet plates 34a-34d have grooved surfaces arranged toward a top of the stack, and the remaining fewer than one half of the magnet plates 36a, 36b have grooved surfaces arranged toward a bottom of the stack. This embodiment, may for example, be advantageously used in the solenoid of FIG. 17, described below.

It is recognized that any number of magnet plates may be asymmetrically mirrored across a symmetry plane (e.g. plane 32), and thus that the fact that six magnet plates are shown in FIG. 3 is not limiting. Thus, any other number of magnet plates, whether odd or even, may be used in an asymmetric design in accordance with the principle illustrated in FIG. 3, according to the magnet's operating requirements. The asymmetric arrangement can be advantageous for situations in which the winding pack is exposed to magnetic fields generated by conductors that are external to those shown in FIG. 3. In this case, the location of the symmetry plane (i.e. plane 32) can be chosen so that the vertical component of the total Lorenz load experienced by each individual conductor is directed toward the symmetry plane.

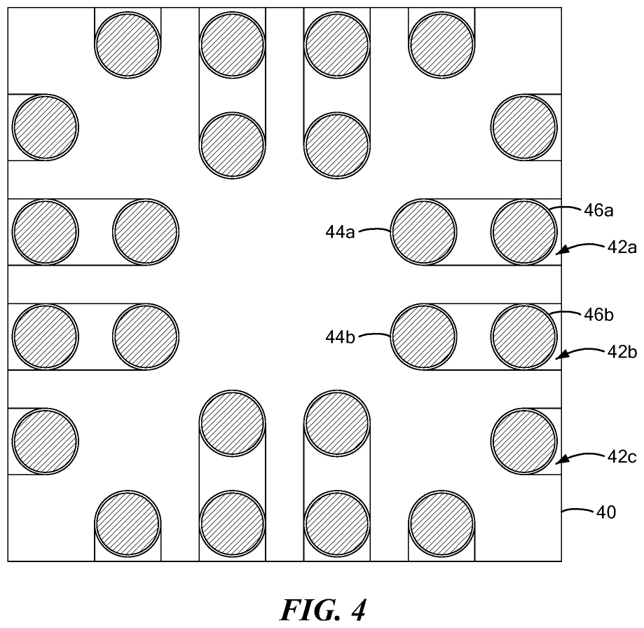

FIG. 4 is a cross-sectional view of a single magnet plate or housing 40 having several grooves (of which grooves 42a, 42b, 42c are illustrative) in which conductors are arranged in radial layers. The single housing shown in FIG. 4 retains all of the conductors, unlike the multiple stacked plates shown in FIGS. 1, 2, and 3. The housing retains some of the conductors in an inner ring of eight conductors (two per side, of which conductors 44a, 44b are illustrative), and an outer ring of sixteen conductors (four per side, of which conductors 46a, 46b are illustrative). To accomplish this configuration, the grooves retaining conductors in both the inner ring and the outer ring (e.g. grooves 42a, 42b) are deeper than the grooves retaining conductors in the outer ring only (e.g. groove 42c).

In contrast to the magnetic self-field generated by the conductors in FIGS. 1, 2, and 3 that draws conductors toward a symmetry plane, the magnetic self-field generated in the configuration of FIG. 4 draws all the conductors radially inward, toward the center of the housing. Therefore, the conductors for the design of FIG. 4 are arranged in radial symmetry so that they are drawn into their grooves and against the structural housing, producing the same functional result as the stacked plate arrangements of FIGS. 1, 2, and 3.

Thus, FIG. 4 shows a housing having grooved surfaces, the housing having a plurality of conductors that each pass through a groove in one of the grooved surfaces. When a current is applied to each of the plurality of conductors to generate a magnetic field, a Lorentz force resulting from the generated magnetic field presses each conductor into its respective groove. It is appreciated that the modifications to the multiple-plate systems described above may apply, where appropriate, to the embodiment shown in FIG. 4.

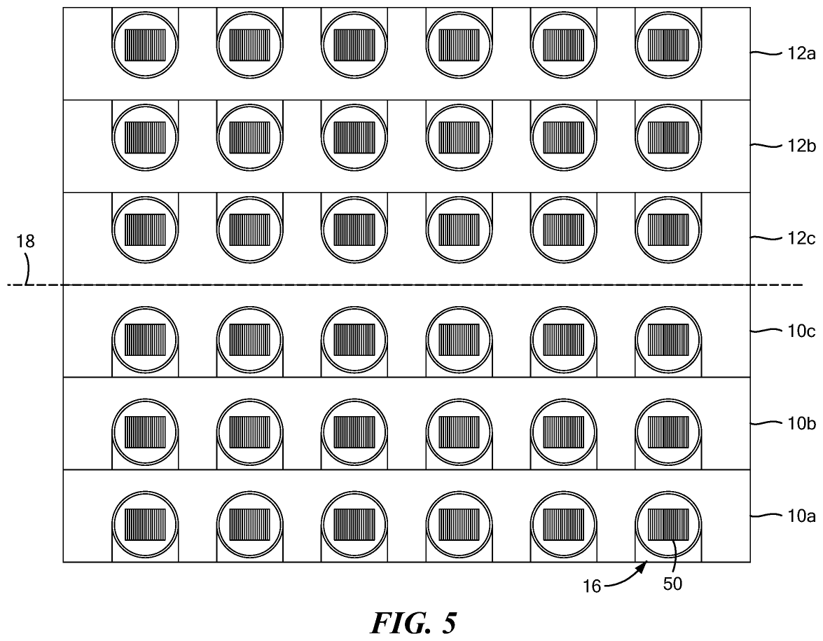

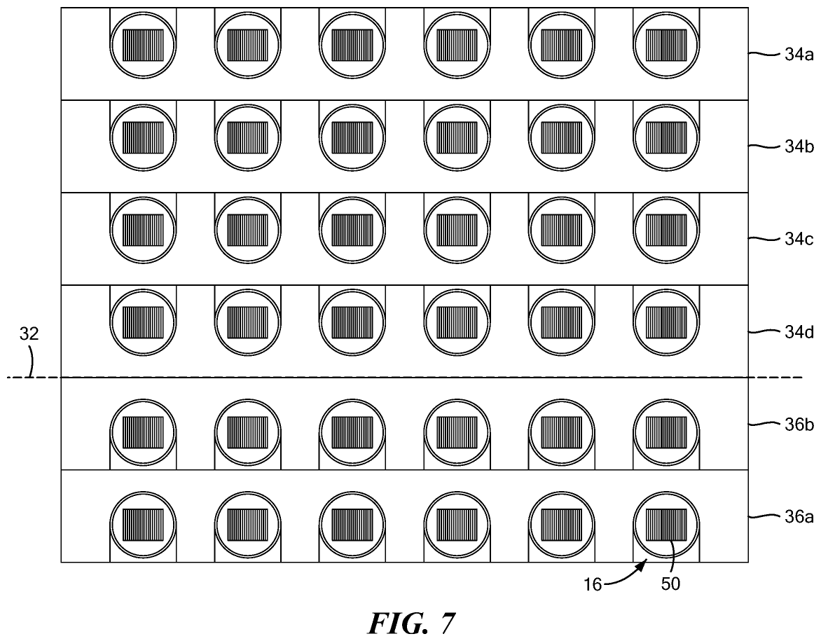

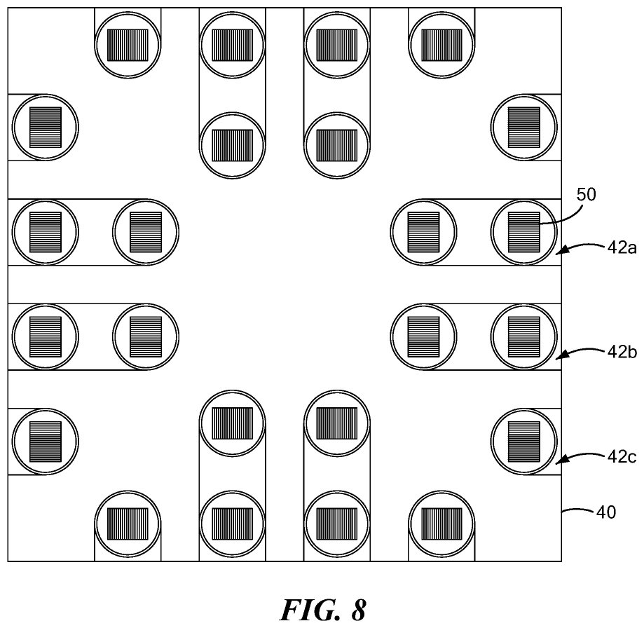

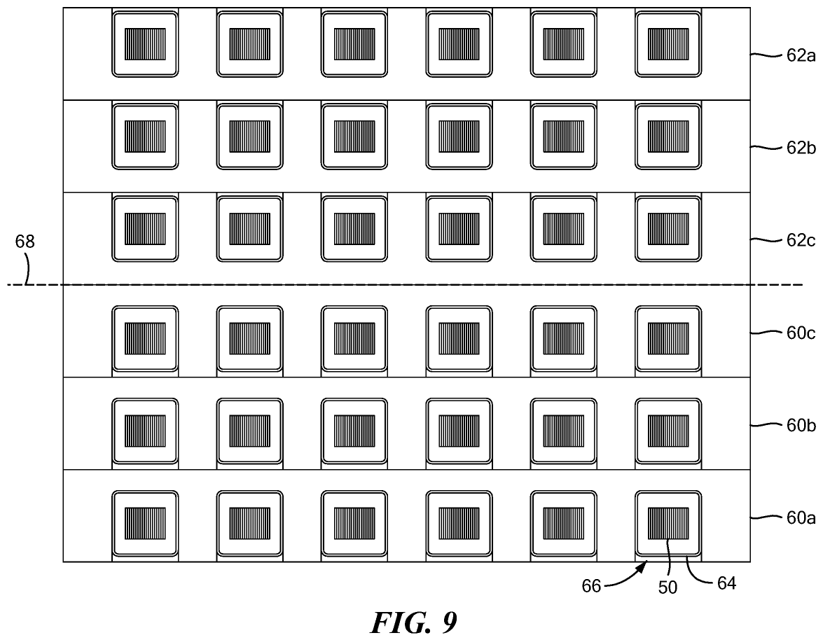

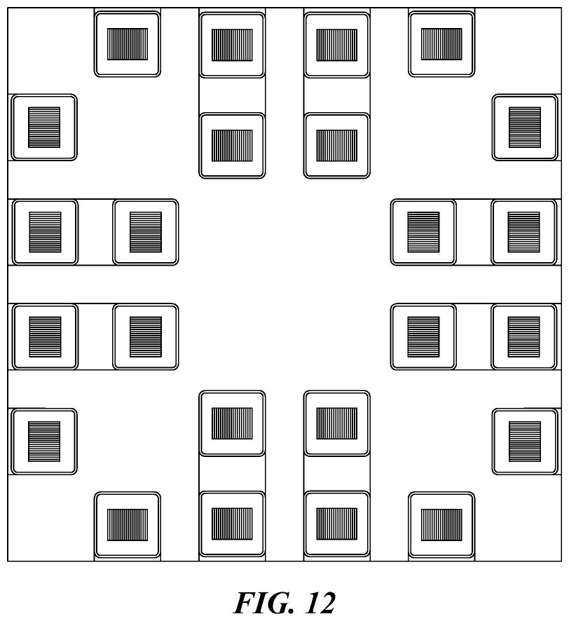

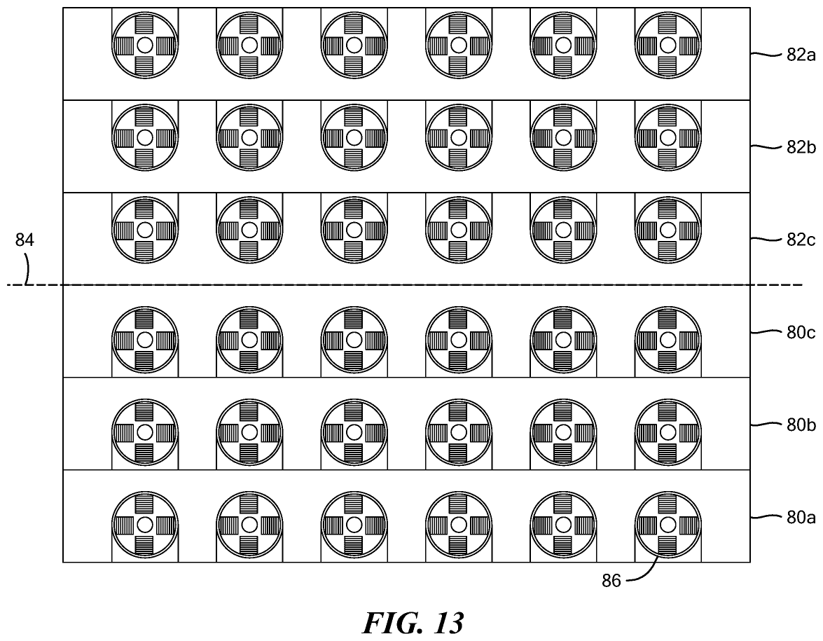

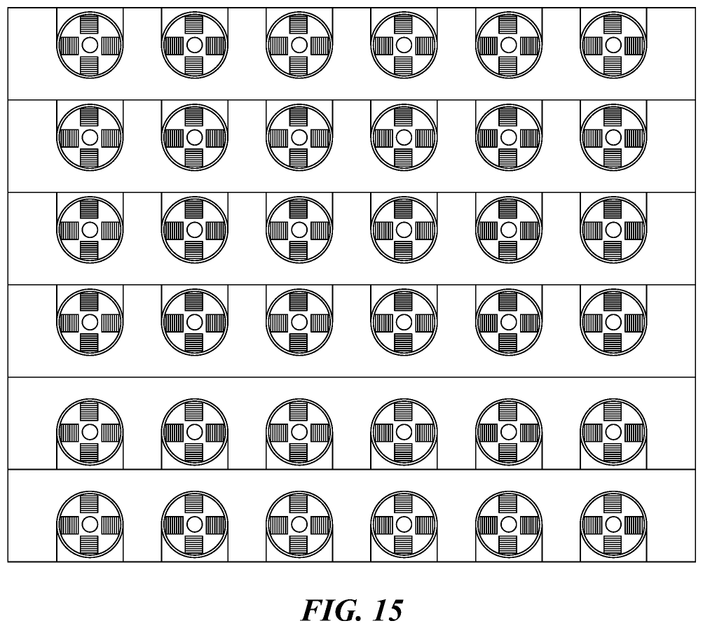

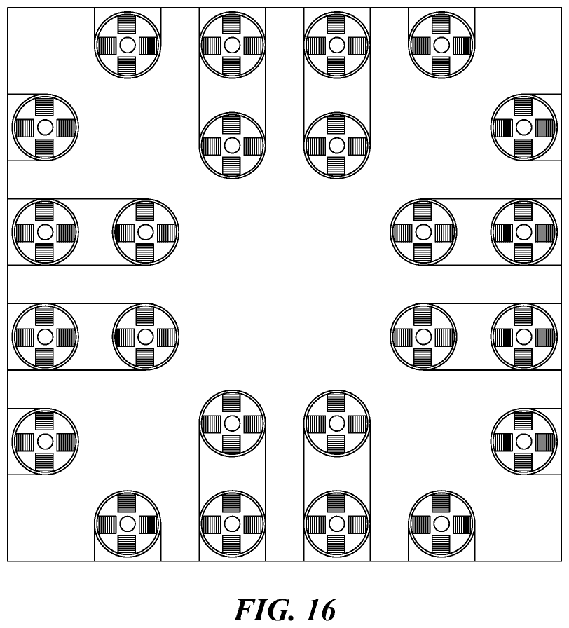

It is appreciated that embodiments of the concepts, techniques, and structures disclosed herein are not dependent on the conductor configuration. Thus, in some embodiments the conductor includes a high temperature superconductor (HTS) made of a homogeneous rare-earth copper oxide (e.g. REBCO), as shown in FIGS. 1 through 4. Other embodiments include HTS tape that is stacked in layers with optional co-wind, as shown in FIGS. 5 through 8 and discussed below. The conductor may have a circular cross-section, or a square cross-section as shown in FIGS. 9 through 12 and discussed below, or some other shape of cross-section. In still other embodiments, multiple HTS tape stacks may be present in a single conductor, and may be arranged around a cooling channel for removing heat as shown in FIGS. 13 through 16 and discussed below.

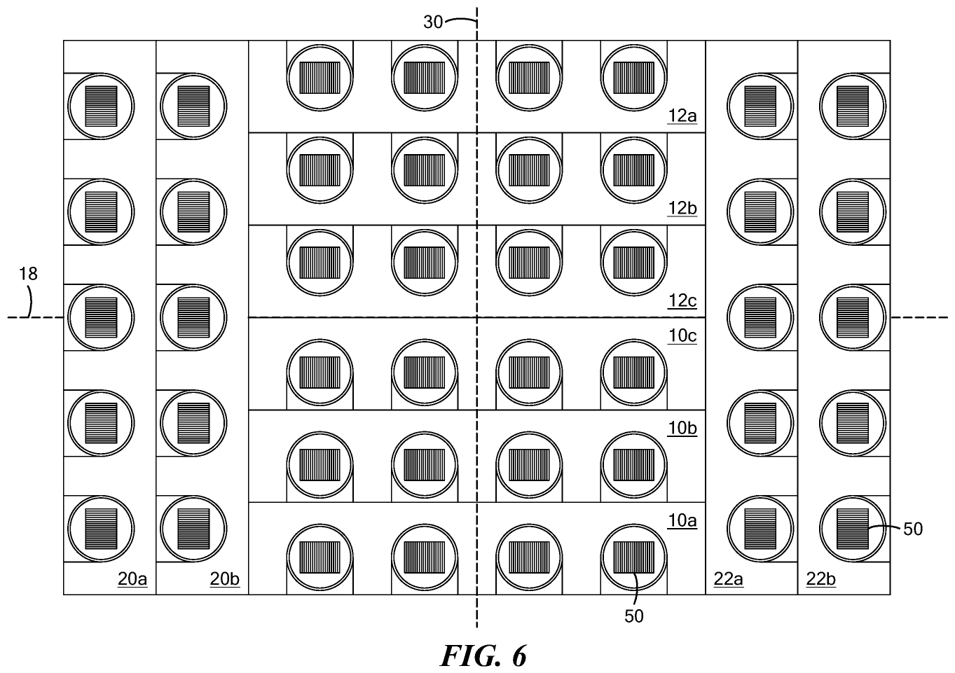

Thus, in FIG. 5 is shown a cross-sectional view of a mirrored stack of magnet plates, each plate containing several grooves, each groove containing a conductor having a circular cross-section and containing a stack of high-temperature superconductor (HTS) tape. The embodiment of FIG. 5 is identical to that of FIG. 1, except that an HTS tape stack 50 is used inside an otherwise homogeneous conductor. Likewise, FIGS. 6, 7, and 8 are respectively identical to FIGS. 2, 3, and 4 but for this change. In particular, it is appreciated that the same magnet plates 10a-10c, 12a-12c, 20a, 20b, 22a, 22b, 34a-34d, 36a, 36b, 40 may be reused with different conductors at different times.

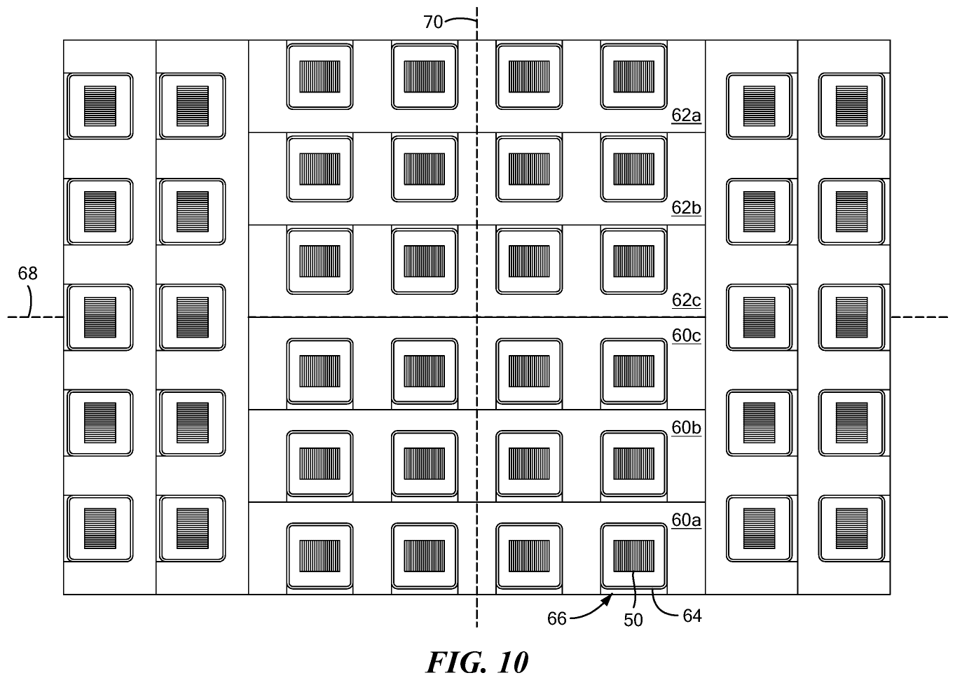

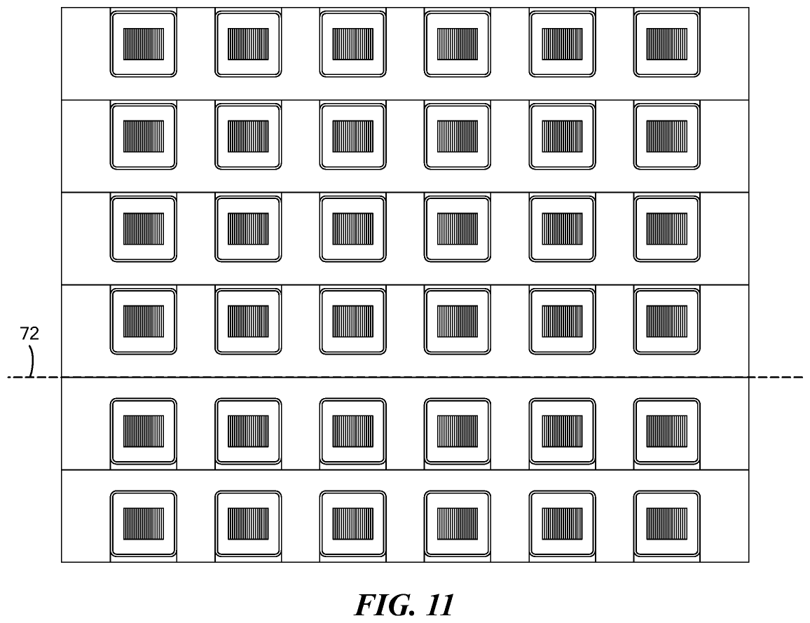

FIG. 9 is a cross-sectional view of a mirrored stack of magnet plates 60a-60c, 62a-62c, each plate containing several grooves (of which groove 66 is illustrative), each groove containing a conductor (of which conductor 64 is illustrative) having a square cross-section containing a stack of high-temperature superconductor (HTS) tape 50. The embodiment of FIG. 9 is similar to that of FIG. 5 insofar as it contains grooved magnet plates with conductors comprising HTS tape stacks, except that the conductors in FIG. 9 have square cross sections rather than circular ones, and the grooves are likewise squarely shaped to securely accommodate such conductors. Likewise, FIGS. 10, 11, and 12 are respectively similar to FIGS. 6, 7, and 8 but for these changes. In particular, FIG. 10 shows a secondary symmetry plane 70, and FIG. 11 shows an off-center symmetry plane 72.

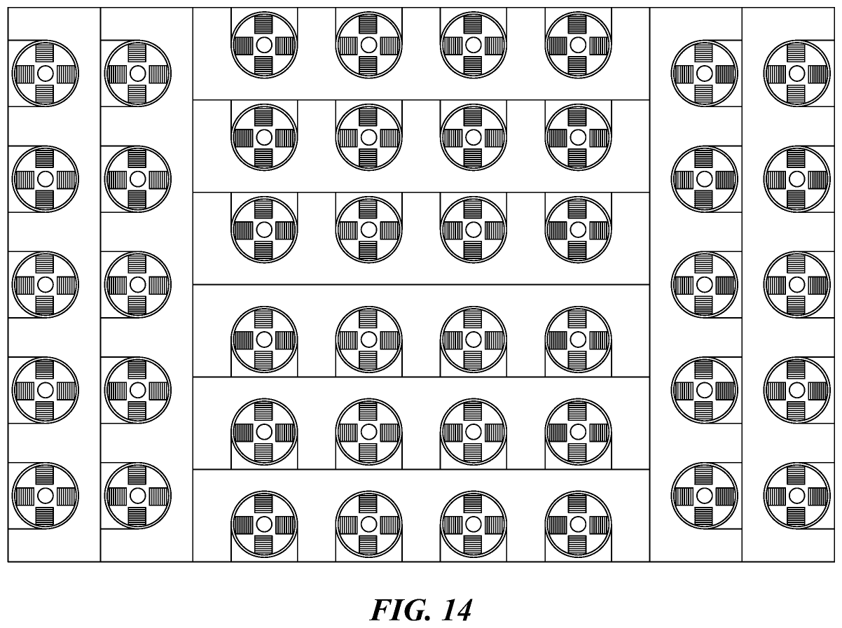

FIG. 13 is a cross-sectional view of a mirrored stack of magnet plates 80a-c, 82a-c, mirrored about a symmetry plane 84, each plate containing several grooves, each groove containing a conductor having a circular cross-section with several stacks of high-temperature superconductor (HTS) tape around a cooling channel. The embodiment of FIG. 13 is similar to that of FIG. 5, except that each conductor (of which conductor 86 is illustrative) includes a plurality of stacks of HTS tape and cooling channel within the conductor. Likewise, FIGS. 14, 15, and 16 are respectively similar to FIGS. 6, 7, and 8 but for this change.

FIG. 17 is a cross-sectional view of several stacks or winding packs 90a, 90b, 90c (collectively, winding packs 90) of magnet plates having different mirroring arrangements for use at different positions in a solenoid, each plate containing several grooves, each groove containing a conductor. Each winding pack may be a single magnet coil having a single conductor wound through several magnet plates. Alternately, each magnet plate may have its own conductor, wound through its multiple grooves, thereby providing a modular design. In general, however, each winding pack experiences a relatively strong local self-field, and relatively weaker local fields generated by the other winding packs. These external fields may cause asymmetries in the fields experienced inside each winding pack during operation, as a function of its location within the solenoid.

The cross section of FIG. 17 reveals that all three winding packs 90a, 90b, 90c use a mirrored, grooved-plate arrangement. The center pack 90b has the mirror reflection plate 92b in the center (as in FIG. 1) while the end packs 90a, 90c have their mirror reflection planes 92a, 92c offset from their centers (as in FIG. 3). The offset reflection planes 92a, 92c for the end packs 90a, 90c are advantageous because their windings experience an overall attractive force toward the center coil 90b, which is in addition to the self-attractive forces among the windings within each end coil 90a, 90c.

In more detail, the local fields in the topmost winding pack 90a during operation are generally toward the center of the pack, with a slight bias toward the center of the solenoid. Three of the magnet plates 94a-94c in the topmost winding pack 90a have grooves in their top surfaces, and the fourth magnet plate 94d has grooves in its bottom surface. This arrangement balances the self-field of this winding pack with the fields generated by the other winding packs so that all conductors are pulled into their grooves. Using the same principles, the bottommost winding pack 90c is the mirror image of the topmost winding pack 90a. Thus, its innermost magnet plate 98a has grooves in its top surface, while the three outermost magnet plates 98b-98d have grooves in their bottom surfaces.

The self-field in the middle winding pack 90b and the sum of the fields generated by the other winding packs both generate Lorentz forces toward the center of the solenoid during operation. The middle winding pack 90b balances the magnetic fields differently than the topmost and bottommost winding packs. Thus, the middle winding pack 90b is purely symmetric about a central symmetry plane 92b. In particular, magnet plates 96a and 96b have grooves in their top surfaces, while magnet plates 96c and 96d have grooves in their bottom surfaces in a perfectly mirrored configuration.

Thus, FIG. 17 shows a solenoid comprising a plurality of magnet winding packs, each winding pack having a plurality of magnet plates, each of the magnet plates having a flat surface and a grooved surface, each of the magnet plates having a conductor that passes through grooves in the grooved surface. The plurality of magnet plates are arranged in each winding pack so that, when a current is applied to the conductor of each of the magnet plates to generate a magnetic field, a Lorentz force resulting from the generated magnetic field presses each conductor into its respective grooves. At least two of the magnet winding packs have different arrangements of magnet plates.

It is appreciated that in embodiments, the number of magnet plates in the various winding packs, and their particular stacking arrangements, may be determined by the operational requirements of the application to which the concepts, techniques, and structures disclosed herein are applied. The particular numbers of plates shown in each stack or winding pack in each of the Figures herein does not necessarily limit the scope of the inventive subject matter.

Persons having ordinary skill in the art may appreciate other embodiments of the concepts, results, and techniques disclosed herein. It is appreciated that superconducting cables and magnet plates configured according to the concepts and techniques described herein may be useful for a wide variety of applications, including applications in which the superconducting cable is wound into a coil to form a magnet. For instance, one such application is conducting nuclear magnetic resonance (NMR) research into, for example, solid state physics, physiology, or proteins, for which such cables may be wound into a magnet. Another application is performing clinical magnetic resonance imaging (MRI) for medical scanning of an organism or a portion thereof, for which compact, high-field magnets are needed. Yet another application is high-field MM, for which large bore solenoids are required. Still another application is for performing magnetic research in physics, chemistry, and materials science. Further applications is in magnets for particle accelerators for materials processing or interrogation; electrical power generators; medical accelerators for proton therapy, radiation therapy, and radiation generation generally; superconducting energy storage; magnetohydrodynamic (MHD) electrical generators; and material separation, such as mining, semiconductor fabrication, and recycling. It is appreciated that the above list of applications is not exhaustive, and there are further applications to which the concepts, processes, and techniques disclosed herein may be put without deviating from their scope.

As used herein, a “high temperature superconductor” or “HTS” refers to a material that has a critical temperature above 30 K, wherein the critical temperature refers to the temperature below which the electrical resistivity of the material drops to zero.

Illustrative examples of arranging magnet plates and conductors within grooves are described herein and illustrated in the drawings. It will be appreciated that the particular size and shape of these grooves are provided merely as examples and that no particular cross-sectional shape or size is implied as being necessary or desirable unless otherwise noted.

Having thus described several aspects of at least one embodiment which illustrate the described concepts, it is to be appreciated that various alterations, modifications, and improvements will readily occur to those skilled in the art. Such alterations, modifications, and improvements are intended to be part of this disclosure, and are intended to be within the spirit and scope of the concepts described herein. Further, though advantages of the concepts described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the concepts described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts described herein may be embodied as a method. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

For purposes of the description above, the terms “upper,” “lower,” “right,” “left,” “vertical,” “horizontal, “top,” “bottom,” and derivatives thereof” shall relate to the described structures and methods, as oriented in the drawing figures. The terms “overlying,” “atop,” “on top,” “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary layers or structures at the interface of the two elements.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A system comprising:
a plurality of magnet plates, each of the magnet plates having a flat surface opposite a grooved surface, each of the magnet plates having a conductor that passes through grooves in the grooved surface;
wherein the plurality of magnet plates are arranged in a stack so that, when a current is applied to the conductor of each of the magnet plates to generate a magnetic field, a Lorentz force resulting from the generated magnetic field presses each conductor into its respective grooves.

2. The system according to claim 1, wherein one half of the magnet plates have grooved surfaces arranged toward a top of the stack, and the other half of the magnet plates have grooved surfaces arranged toward a bottom of the stack.

3. The system according to claim 2, further comprising:
a second plurality of magnet plates, each of the second plurality of magnet plates having a flat surface and a grooved surface, each of the second plurality of magnet plates having a conductor that passes through grooves in the grooved surface;
wherein one half of the second plurality of magnet plates have grooved surfaces arranged toward a left of the stack, and the other half of the magnet plates have grooved surfaces arranged toward a right of the stack.

4. The system according to claim 1, wherein greater than one half of the magnet plates have grooved surfaces arranged toward a top of the stack, and the remaining fewer than one half of the magnet plates have grooved surfaces arranged toward a bottom of the stack.

5. The system according to claim 1, wherein at least one of the magnet plates has a conductor that comprises a homogeneous rare-earth copper oxide superconductor.

6. The system according to claim 1, wherein at least one of the magnet plates has a conductor that comprises a stack of high temperature superconductor (HTS) tape.

7. The system according to claim 6, wherein the conductor has a circular cross-section.

8. The system according to claim 6, wherein the conductor has a square cross-section.

9. The system according to claim 1, wherein at least one of the magnet plates has a conductor that comprises a plurality of stacks of high temperature superconductor (HTS) tape.

10. The system according to claim 9, wherein the plurality of stacks of HTS tape are arranged around a cooling channel for removing heat generated by the plurality of stacks of HTS tape.

11. The system according to claim 1, wherein at least one of the magnet plates has a conductor that is soldered into the grooves in the grooved surface.

12. The system according to claim 1, wherein at least one of the magnet plates has a conductor that is potted into the grooves in the grooved surface using an epoxy.

13. The system according to claim 1, wherein at least one of the magnet plates comprises a steel.

14. The system according to claim 1, wherein at least one of the magnet plates comprises a glass-fiber composite.

15. A system comprising:
a housing having grooved surfaces, the housing having a plurality of conductors that each pass through a groove in one of the grooved surfaces;
wherein when a current is applied to each of the plurality of conductors to generate a magnetic field, a Lorentz force resulting from the generated magnetic field presses each conductor into its respective groove.

16. The system according to claim 15, wherein at least one of the plurality of conductors comprises a homogeneous rare-earth copper oxide superconductor.

17. The system according to claim 15, wherein at least one of the plurality of conductors comprises a stack of high temperature superconductor (HTS) tape.

18. The system according to claim 17, wherein the conductor has a circular cross-section.

19. The system according to claim 17, wherein the conductor has a square cross-section.

20. The system according to claim 15, wherein at least one of the plurality of conductors comprises a plurality of stacks of high temperature superconductor (HTS) tape.

21. The system according to claim 20, wherein the plurality of stacks of HTS tape are arranged around a cooling channel for removing heat generated by the plurality of stacks of HTS tape.

22. The system according to claim 15, wherein at least one of the plurality of conductors is soldered into its groove.

23. The system according to claim 15, wherein at least one of the plurality of conductors is potted into its groove using an epoxy.

24. The system according to claim 15, wherein the housing comprises a steel.

25. The system according to claim 15, wherein the housing comprises a glass-fiber composite.

26. A magnet system comprising a plurality of magnet winding packs, each winding pack having a plurality of magnet plates, each of the magnet plates having a flat surface opposite a grooved surface, each of the magnet plates having a conductor that passes through grooves in the grooved surface;
wherein the plurality of magnet plates are arranged in each winding pack so that, when a current is applied to the conductor of each of the magnet plates to generate a magnetic field, a Lorentz force resulting from the generated magnetic field presses each conductor into its respective grooves.

27. The magnet system according to claim 26, wherein at least two of the magnet winding packs have different arrangements of magnet plates.

28. The magnet system according to claim 26, arranged as a solenoid or arranged as a toroid.

29. A magnet comprising:
a plurality of plates, each of the plates having a flat surface opposite a grooved surface, each of the plates comprising a conductor that passes through grooves in the grooved surface,
wherein the plurality of plates includes a first plate and a second plate arranged such that the flat surface of the first plate and the flat surface of the second plate both lie between the grooved surface of the first plate and the grooved surface of the second plate.

30. The magnet of claim 29, wherein the flat surface of the first plate contacts the flat surface of the second plate.

31. The magnet of claim 29, wherein the flat surface of the first plate and the flat surface of the second plate contact opposing sides of a layer of insulation.

32. The magnet of claim 29, wherein at least one of the plates comprises a conductor having a stack of high temperature superconductor tapes.

33. The magnet of claim 32, wherein the conductor has a circular cross-section.

34. The magnet of claim 32, wherein the conductor has a square cross-section.
